(19) United States
(12) Patent Application Publication
(10) Pub. No.: US 2024/0068807 A1
(43) Pub. Date: Feb. 29, 2024

(54) REAL-TIME PREFORM MATERIAL THICKNESS MEASUREMENT

(71) Applicant: GOODRICH CORPORATION, Charlotte, NC (US)

(72) Inventors: Samuel Moore, Pueblo, CO (US); John S. Linck, Pueblo, CO (US); Cameron L. Martinez, Pueblo, CO (US)

(73) Assignee: GOODRICH CORPORATION, Charlotte, NC (US)

(21) Appl. No.: 17/893,808

(22) Filed: Aug. 23, 2022

(51) Int. Cl. G01B 17/02; G01N 21/25

(52) U.S. Cl. CPC G01B 17/02; G01N 21/251

(57) ABSTRACT

A system is provided for measuring a thickness of a preform material. The system includes a material detection device and a controller, wherein the controller is configured to: receive, from the material detection device, a signal indicating a presence of the preform material; responsive to receiving the signal, receive a first set of measurements along at least a portion of a length of the preform material; convert the first set of measurements into a second set of measurements; and record the second set of measurements.

### FIELD

The present disclosure relates generally to automatically measuring preform material thickness in real-time.

### BACKGROUND

Composite bodies are utilized in various industries, including the aerospace industry. The composite bodies start with a preform that is formed using layers of textile material. In the building of a non-woven preform for certain applications including carbon-carbon aircraft brake disks and thermal protection systems, a thickness of the non-woven preform material is measured as it passed into a loom of the non-woven preform forming machinery and/or when the preform material is retracted from the loom.

### SUMMARY

According to various embodiments of the present disclosure, a system for measuring a thickness of a preform material is provided. The system includes a material detection device; and a controller, where the controller is configured to: receive, from the material detection device, a signal indicating a presence of the preform material; responsive to receiving the signal, receive a first set of measurements along at least a portion of a length of the preform material; convert the first set of measurements into a second set of measurements; and record the second set of measurements.

In various embodiments, the material detection device is at least one of a sensor or a switch. In various embodiments, the material detection device is a full spectrum sensor that is configured to detect a color associated with the preform material. In various embodiments, measurements in the first set of measurements are at least one of electrical current signals or electrical voltage signals.

In various embodiments, the system further includes: an electromechanical transducer device, where measurements in the first set of measurements are detected by the electromechanical transducer device. In various embodiments, the electromechanical transducer device is a linear variable differential transducer. In various embodiments, the system further includes a roller, where the electromechanical transducer device is coupled to the roller and where the roller is configured to roll along a top layer of the preform material. In various embodiments, the system further includes a material measurement device, where the roller is further coupled to the material measurement device and where the material measurement device controls contact of the roller with the preform material. In various embodiments, measurements in the second set of measurements are thickness measurements. In various embodiments, the second set of measurements is recorded in real-time as the preform material moves in either a first direction or a second direction, where the first direction is the preform material advancing into a loom of a preform forming machine and where the second direction is the preform material retracting out of the loom of the preform forming machine.

Also disclosed herein is a method for measuring a thickness of a preform material. The method includes receiving, by a controller, a signal indicating a presence of the preform material; responsive to receiving the signal, receiving, by the controller, a first set of measurements along at least a portion a length of the preform material; converting, by the controller, the first set of measurements into a second set of measurements; and recording, by the controller, the second set of measurements.

In various embodiments, the presence of the preform material is detected by at least one of a sensor or a switch. In various embodiments, the sensor is a full spectrum sensor that is programmed to detect a color associated with the preform material. In various embodiments, measurements in the first set of measurements are at least one of electrical current signals or electrical voltage signals. In various embodiments, measurements in the first set of measurements are detected by an electromechanical transducer device. In various embodiments, the electromechanical transducer device is a linear variable differential transducer. In various embodiments, the electromechanical transducer device is coupled to a roller that is configured to roll along a top layer of the preform material. In various embodiments, the roller is further coupled to a material measurement device that controls contact of the roller with the preform material. In various embodiments, measurements in the second set of measurements are thickness measurements. In various embodiments, the second set of measurements is recorded in real-time as the preform material moves in either a first direction or a second direction, where the first direction is the preform material advancing into a loom of a preform forming machine and where the second direction is the preform material retracting out of the loom of the preform forming machine.

### BRIEF DESCRIPTION OF THE DRAWINGS

FIG. 1 illustrates a cross sectional view of an aircraft wheel braking assembly, in accordance with various embodiments.

FIG. 2 illustrates a perspective of fibrous preform, in accordance with various embodiments.

FIG. 3 illustrates a system for automatically measuring a thickness of preform material, in accordance with various embodiments.

FIG. 4 illustrates a front view of a thickness measurement system of a preform forming machine in a non-thickness measuring state, in accordance with various embodiments.

FIG. 5 illustrates a side view of a thickness measurement system of a preform forming machine in a non-thickness measuring state, in accordance with various embodiments.

FIG. 6 illustrates a front view of a thickness measurement system of a preform forming machine in a thickness measuring state, in accordance with various embodiments.

FIG. 7 illustrates a side view of a thickness measurement system of a preform forming machine in a thickness measuring state, in accordance with various embodiments.

FIG. 8 illustrates a method for measuring a thickness of preform material, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

In some current preform forming systems, a set of textile materials, hereinafter referred to as a preform material, is fed into and out of a loom of the preform forming machinery. In some current preform forming systems, while in the loom, the preform material is needled, which compresses the preform material. In some current preform forming systems, human operators manually measure a thickness of the preform material at various locations along a length and width of the preform material as the preform material passes into the loom and again when the preform material is retracted from the loom. As each measurement is made, the human operator hand records the thickness data. This, process of hand measuring and hand recording the thickness measurements takes time and manpower. Additionally, such human processes may be prone to error due to human contact in the measuring process and in recording the data.

Disclosed herein are systems and methods for automatically measuring a thickness of the preform material in real-time. In various embodiments, a material detection device detects an advancing piece of preform material. In various embodiments, once the preform material is detected, a material measurement device, which includes a roller wheel attached to a distal end of the material measurement device, is switched from an up position, i.e., a non-thickness measuring position, to a down position, i.e., a thickness measuring position, such that the roller wheel contacts the preform material. In various embodiments, as the preform material passes into the loom, the roller wheel rides across the preform material and an electromechanical transducer device coupled to the material measurement device converts a rectilinear, i.e., up and down, motion of the roller wheel at various locations along the length of the preform material into corresponding electrical signals, which correlate to thickness measurement of the preform material at the various locations where the measurement is read. These measurements are read and recorded in real-time as the preform material traverses into and out of the loom of the preform forming machinery. By automatically reading the measurements in real time, human contact is limited, which optimizes an impact of operator time and decreases an amount of error by providing accurate data collection.

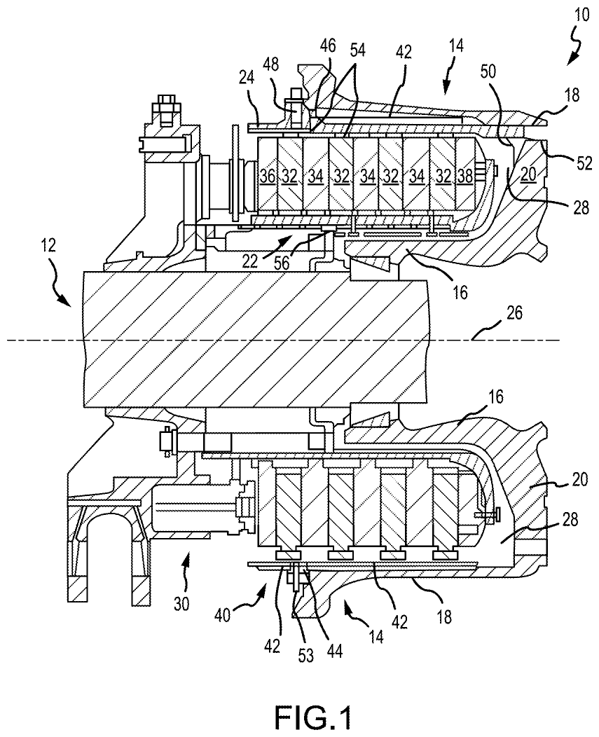

Referring now to FIG. 1, in accordance with various embodiments, aircraft wheel braking assembly such as may be found on an aircraft, is illustrated. In various embodiments, aircraft wheel braking assembly 10 may include a bogie axle 12, a wheel 14 including a hub 16 and a wheel well 18, a web 20, a torque take-out assembly 22, one or more torque bars 24, a wheel rotational axis 26, a wheel well recess 28, an actuator 30, multiple brake rotors 32, multiple brake stators 34, a pressure plate 36, an end plate 38, a heat shield 40, multiple heat shield sections 42, multiple heat shield carriers 44, an air gap 46, multiple torque bar bolts 48, a torque bar pin 50, a wheel web hole 52, multiple heat shield fasteners 53, multiple rotor lugs 54, and multiple stator slots 56.

In various embodiments, the various components of aircraft wheel braking assembly 10 may be subjected to the application of compositions and methods for protecting the components from oxidation.

Brake disks (e.g., interleaved rotors 32 and stators 34) are disposed in wheel well recess 28 of wheel well 18. Rotors 32 are secured to torque bars 24 for rotation with wheel 14, while stators 34 are engaged with torque take-out assembly 22. At least one actuator 30 is operable to compress interleaved rotors 32 and stators 34 for stopping the aircraft. In this example, actuator 30 is shown as a hydraulically actuated piston, but many types of actuators are suitable, such as an electromechanical actuator. Pressure plate 36 and end plate 38 are disposed at opposite ends of the interleaved rotors 32 and stators 34. Rotors 32 and stators 34 can comprise any material suitable for friction disks, including ceramics or carbon materials, such as a carbon/carbon composite.

Through compression of interleaved rotors 32 and stators 34 between pressure plates 36 and end plate 38, the resulting frictional contact slows rotation of wheel 14. Torque take-out assembly 22 is secured to a stationary portion of the landing gear truck such as a bogie beam or other landing gear strut, such that torque take-out assembly 22 and stators 34 are prevented from rotating during braking of the aircraft.

Carbon-carbon composites (also referred to herein as composite structures, composite substrates, and carbon-carbon composite structures, interchangeably) in the friction disks may operate as a heat sink to absorb large amounts of kinetic energy converted to heat during slowing of the aircraft. Heat shield 40 may reflect thermal energy away from wheel well 18 and back toward rotors 32 and stators 34. Heat shield 40 is attached to wheel 14 and is concentric with wheel well 18. Individual heat shield sections 42 may be secured in place between wheel well 18 and rotors 32 by respective heat shield carriers 44 fixed to wheel well 18. Air gap 46 is defined annularly between heat shield segments 42 and wheel well 18.

Torque bars 24 and heat shield carriers 44 can be secured to wheel 14 using bolts or other fasteners. Torque bar bolts 48 can extend through a hole formed in a flange or other mounting surface on wheel 14. Each torque bar 24 can optionally include at least one torque bar pin 50 at an end opposite torque bar bolts 48, such that torque bar pin 50 can be received through wheel web hole 52 in web 20. Heat shield sections 42 and respective heat shield carriers 44 can then be fastened to wheel well 18 by heat shield fasteners 53.

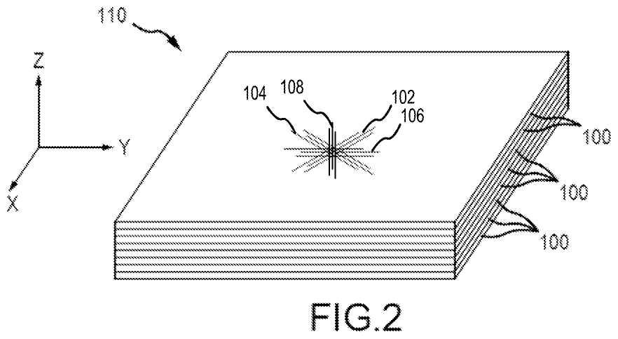

Referring now to FIG. 2, in accordance with various embodiments, a fibrous preform is illustrated. Fibrous preform 110 may comprise a plurality of sheets of fabric 100 stacked together. Sheets of fabric 100 may all be oriented in a common direction so that their respective plurality of fibers (i.e., first plurality of fibers 102, second plurality of fibers 104, third plurality of fibers 106, and/or fourth plurality of fibers 108) are commonly oriented, or may be alternatingly rotated so that their respective plurality of fibers extend in different direction in a crisscross pattern. Fibrous preform 110 may comprise one or more layers of a non-woven fabric, one or more layers of a woven fabric (e.g., plain weave, 5-harness satin weave, 8-harness satin weave, etc.), or combinations thereof. Fibrous preform 110 may comprise PAN or OPF fibers extending in three directions and leaving a plurality of pores or open spaces and may be prepared for shape-forming, compression, and carbonization. In various embodiments, fibrous preform 110 is formed by stacking layers of PAN or OPF fibers and superimposing the layers (e.g., by stacking sheets of fabric 100). The layers may be needled perpendicularly to each other (i.e., along the Z-direction) with barbed, textile needles or barbless, structuring needles. In various embodiments, the layers are needled at an angle of between 0° and 60° (e.g., 0°, 30°, 45°, and/or 60° with respect to the Z-direction to each other. The needling process generates a series of z-fibers through fibrous preform 110 that extend perpendicularly to the fibrous layers. The z-fibers are generated through the action of the needles pushing fibers from within the layer (x-y or in-plane) and reorienting them in the z-direction (through-thickness). Needling of the fibrous preform may be done as one or more layers are added to the stack or may be done after the entire stack of layers is formed. The needles may also penetrate through only a portion of fibrous preform 110, or may penetrate through the entire fibrous preform 110. In addition, resins are sometimes added to fibrous preform 110 by either injecting the resin into the preform following construction or coating the fibers or layers prior to forming the fibrous preform 110. The needling process may take into account needling parameters optimized to maintain fiber orientation, minimize in-plane fiber damage, and maintain target interlaminar properties. After needling the fibrous preform 110, the fibrous preform 110 may be both compressed to higher fiber volume ratio and formed to shape in a single-step shape-forming process; though it is also contemplated that in various embodiments the fibrous preform 110 is compressed and shape formed without undergoing the needling process.

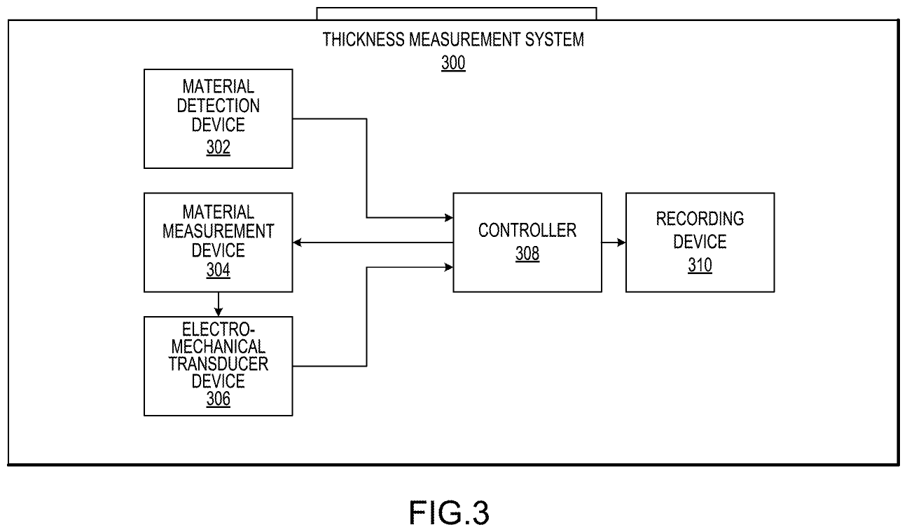

Turning to FIG. 3, in accordance with various embodiments, a system for automatically measuring a thickness of preform material, such as fibrous preform 110 of FIG. 1, is illustrated. In various embodiments, the thickness measurement system 300 may include a material detection device 302, a material measurement device 304, an electromechanical transducer device 306, a controller 308, and a recording device 310. In various embodiments, as the preform material advances in a first direction into a loom, the material detection device 302 detects a presence of the preform material advancing in the first direction into the loom. In various embodiments, the material detection device 302 may be a sensor or a switch, among others. In various embodiments, the material detection device 302 is a full spectrum sensor or optical sensor, among others, that is programmed to detect a color associated with the preform material. In various embodiments, upon detection of the preform material, the material detection device 302 sends a signal to the controller 308.

In various embodiments, a predetermined time after the detection of the advancing preform material, the controller 308 sends a signal to the material measurement device 304 to transition from a first position, i.e., a non-thickness measuring position, to a second position, i.e., a thickness measuring position. In various embodiments, the predetermined time after detection of the advancing preform material may be 1 to 9 seconds. In various embodiments, the predetermined time after detection of the advancing preform material may be 3 to 7 seconds. In various embodiments, the predetermined time after detection of the advancing preform material may be 4 to 6 seconds. In various embodiments, the material measurement device 304 is a solenoid or an actuator, among others. In various embodiments, the material measurement device 304 includes a proximal end and a distal end. In various embodiments, the proximal end is a non-movable, non-preform material facing end and the distal end is a movable, preform material facing end. In various embodiments, a roller is coupled to the distal end of the material measurement device 304 via a bracket. In various embodiments, in transitioning from the first position to the second position, the distal end of the material measurement device 304 extends in a first direction toward a top layer of the preform material. In various embodiments, the distal end of the material measurement device 304 extending in the first direction is a direction perpendicular to the preform material advancing in the first direction into the loom. In various embodiments, the distal end of the material measurement device 304 extends until the roller wheel contacts the preform material without compressing the preform material. In that regard, the roller wheel may move along an upper surface of the preform material as the preform material advances in the first direction into the loom, the roller wheel is able to move up and down with variations in the thickness of the preform material.

In various embodiments, the electromechanical transducer device 306 may be a linear variable differential transducer (LVDT), linear encoder, or linear transducer, or the like. In various embodiments, the electromechanical transducer device 306 includes a proximal end and a distal end. In various embodiments, the proximal end of the electromechanical transducer device 306 is non-movably affixed in proximity to the proximal end of the material measurement device 304. In various embodiments, the distal end of the electromechanical transducer device 306 is movably affixed to the movable distal end of the material measurement device 304. In that regard, as the roller wheel moves along the preform material as the preform material advances in the first direction into the loom, movement of the roller wheel in an up or down direction is translated to the movable distal end of the electromechanical transducer device 306. In various embodiments, the electromechanical transducer device 306 converts the detected up and down mechanical movements, i.e., rectilinear motions, into a first set of measurements, such as electrical current signals or electrical voltage signals, or the like. In various embodiments, the controller 308 receives the first set of measurements from the electromechanical transducer device 306 and converts the first set of measurements into a second set of measurements, such as thickness measurements.

The controller 308 may include a logic device such as one or more of a central processing unit (CPU), an accelerated processing unit (APU), a digital signal processor (DSP), a field programmable gate array (FPGA), an application specific integrated circuit (ASIC), or the like. In various embodiments, the controller 308 may further include any non-transitory memory known in the art. The memory may store instructions usable by the controller 308 to perform operations as described herein. In that regard, the controller 308 utilizes instructions stored in the memory, such as a voltage to measurement formula, to convert the first set of measurements to a second set of measurements. In various embodiments, the controller 308 receives numerous signals from the electromechanical transducer device 306 as the roller wheel rides across the preform material along the length of the preform material. The controller 308 receives, converts, and sends the determined thickness measurements in real-time to recording device 310, which may also be any non-transitory memory known in the art. In that regard, the recording device 310 records and/or stores the thickness measurements. In various embodiments, as the preform material advances entirely into the loom in the first direction, the material detection device 302 will identify the absence of the preform material and which will cause the material measurement device 304 to transition from the second position, i.e., the thickness measuring position, to the first position, i.e., the non-thickness measuring position, such that the distal end of the material measurement device 304 retracts in a second direction away from where the preform material was previously located.

In addition to detecting and recording thickness measurements as the preform material advances in a first direction into the loom, a similar operation may be performed as the preform material is retracted from the loom in a second direction out of the loom that is opposite of the first direction into the loom. That is, in various embodiments, as the preform material retracts out of the loom, the material detection device 302 detects a presence of the preform material retracting in the second direction out of the loom. In various embodiments, a predetermined time after the detection of the retracting preform material, the controller 308 sends a signal to the material measurement device 304 to transition from the first position to the second position. In various embodiments, the roller wheel may move along the upper surface of the preform material as the preform material retracts in the second direction out of the loom, and movement of the roller wheel in an up or down direction is translated to the movable distal end of the electromechanical transducer device 306 in the same manner described above. In various embodiments, the electromechanical transducer device 306 converts the detected up and down mechanical movements, i.e., rectilinear motions, into a first set of measurements, such as electrical current signals or electrical voltage signals. In various embodiments, the controller 308 receives the first set of measurements from the electromechanical transducer device 306 and converts the received first set of measurements to a second set of measurement, such as thickness measurements, which are recorded in recording device 310. By automatically reading the measurements in real time, operator interaction is limited, which may enhance an impact of operator time and may decrease an amount of error by providing accurate and consistent data collection.

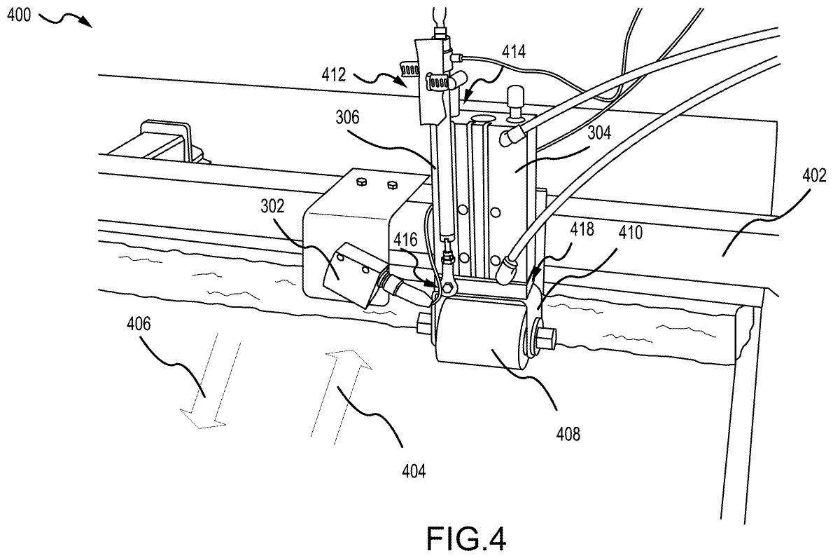

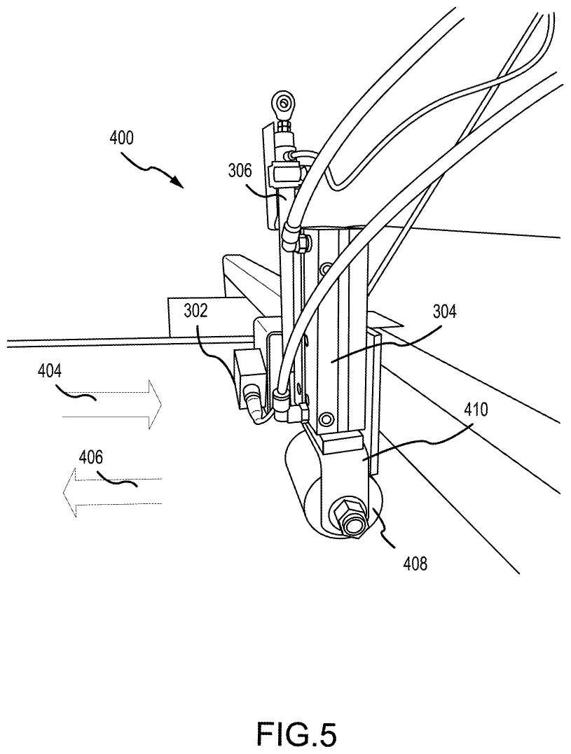

Turning to FIGS. 4 and 5, in accordance with various embodiments, a front view of a thickness measurement system 400 of a preform forming machine in a non-thickness measuring state is illustrated in FIG. 4, and a side view of a thickness measurement system 400 of a preform forming machine in a non-thickness measuring state is illustrated in FIG. 5. In various embodiments, the thickness measurement system 400 includes the material detection device 302, the material measurement device 304, the electromechanical transducer device 306, a controller (e.g., the controller 308 shown in FIG. 3), and a recording device (e.g., the recording device 310 shown in FIG. 3). In various embodiments, the material detection device 302 is coupled to a support structure 402. In various embodiments, the preform material advances into the loom in a first direction 404 and retracts from the loom in the second direction 406 opposite the first direction 404. In various embodiments, material measurement device 304 is coupled to the support structure 402 and roller 408 is coupled to the distal end of the material measurement device 304 via a bracket 410. In various embodiments, a proximal end 412 of the electromechanical transducer device 306 is non-movably affixed in proximity to a proximal end 414 of the material measurement device 304. In various embodiments, a distal end 416 of the electromechanical transducer device 306 is movably affixed to a movable distal end 418 of the material measurement device 304. In FIGS. 4 and 5, the material measurement device 304 is shown in the first position, i.e., a non-thickness measuring position.

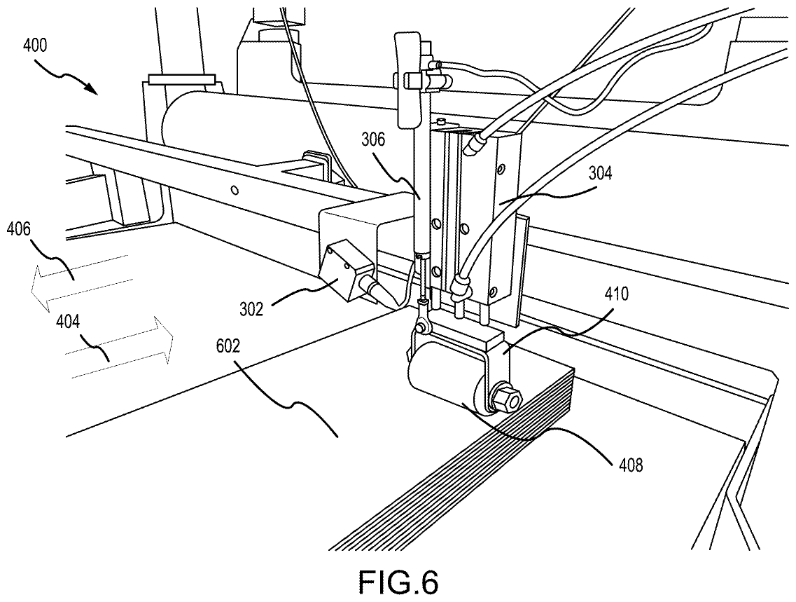

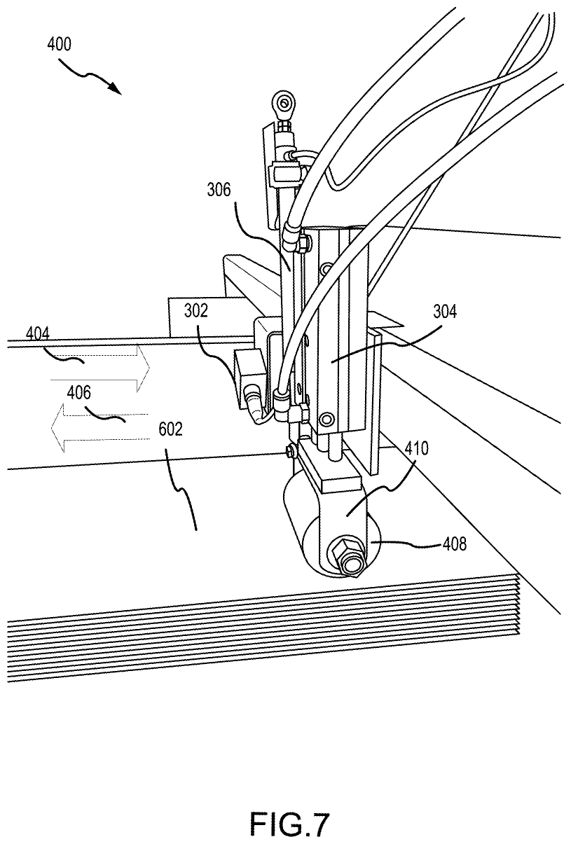

Turning to FIGS. 6 and 7, in accordance with various embodiments, a front view of the thickness measurement system 400 of the preform forming machine in a thickness measuring state is illustrated in FIG. 6, and a side view of the thickness measurement system 400 of the preform forming machine in the thickness measuring state is illustrated in FIG. 7. In various embodiments, preform material 602 advances into the loom in the first direction 404 and retracts from the loom in the second direction 406 opposite the first direction 404. As illustrated, the material detection device 302 has detected the presence of preform material 602. Thus, the material measurement device 304 is shown in the second position, i.e., the thickness measuring position, where roller 408 is in contact with the preform material 602.

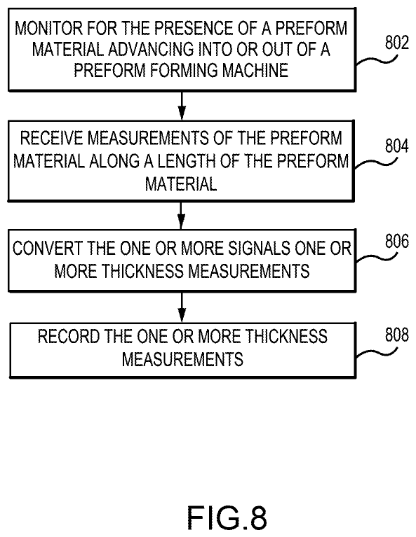

Referring now to FIG. 8, in accordance with various embodiments, a method for measuring a thickness of preform material by the thickness measurement system 400 is illustrated. For ease of description, the method 800 is described with reference to FIGS. 1 thru 7. At block 802, the controller receives a signal from the material detection device 302 indicating a presence of a preform material 602 advancing into or out of a preform forming machine. At block 804, responsive to preform material 602 being detected, the controller 308 receives first measurements, from the electromechanical transducer device 306, of the preform material 602 along a length of the preform material 602. At block 806, the controller 308 converts the one or more signals one or more second measurement, i.e., thickness measurements. At block 808, the controller 308 records the one or more thickness measurements via the recording device 310.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system for measuring a thickness of a preform material, the system comprising:
a material detection device; and
a controller, wherein the controller is configured to:
receive, from the material detection device, a signal indicating a presence of the preform material;
responsive to receiving the signal, receive a first set of measurements along at least a portion of a length of the preform material;
convert the first set of measurements into a second set of measurements; and
record the second set of measurements.

2. The system of claim 1, wherein the material detection device is at least one of a sensor or a switch.

3. The system of claim 1, wherein the material detection device is a full spectrum sensor that is configured to detect a color associated with the preform material.

4. The system of claim 1, wherein measurements in the first set of measurements are at least one of electrical current signals or electrical voltage signals.

5. The system of claim 1, further comprising:
an electromechanical transducer device, wherein measurements in the first set of measurements are detected by the electromechanical transducer device.

6. The system of claim 5, wherein the electromechanical transducer device is a linear variable differential transducer.

7. The system of claim 6, further comprising:
a roller, wherein the electromechanical transducer device is coupled to the roller and wherein the roller is configured to roll along a top layer of the preform material.

8. The system of claim 7, further comprising:
a material measurement device, wherein the roller is further coupled to the material measurement device and wherein the material measurement device controls contact of the roller with the preform material.

9. The system of claim 1, wherein measurements in the second set of measurements are thickness measurements.

10. The system of claim 1, wherein the second set of measurements is recorded in real-time as the preform material moves in either a first direction or a second direction, wherein the first direction is the preform material advancing into a loom of a preform forming machine, and wherein the second direction is the preform material retracting out of the loom of the preform forming machine.

11. A method measuring a thickness of a preform material, comprising:
receiving, by a controller, a signal indicating a presence of the preform material;
responsive to receiving the signal, receiving, by the controller, a first set of measurements along at least a portion of a length of the preform material;
converting, by the controller, the first set of measurements into a second set of measurements; and
recording, by the controller, the second set of measurements.

12. The method of claim 11, wherein the presence of the preform material is detected by at least one of a sensor or a switch.

13. The method of claim 12, wherein the sensor is a full spectrum sensor that is programmed to detect a color associated with the preform material.

14. The method of claim 11, wherein measurements in the first set of measurements are at least one of electrical current signals or electrical voltage signals.

15. The method of claim 11, wherein measurements in the first set of measurements are detected by an electromechanical transducer device.

16. The method of claim 15, wherein the electromechanical transducer device is a linear variable differential transducer.

17. The method of claim 16, wherein the electromechanical transducer device is coupled to a roller that is configured to roll along a top layer of the preform material.

18. The method of claim 17, wherein the roller is further coupled to a material measurement device that controls contact of the roller with the preform material.

19. The method of claim 11, wherein measurements in the second set of measurements are thickness measurements.

20. The method of claim 11, wherein the second set of measurements is recorded in real-time as the preform material moves in either a first direction or a second direction, wherein the first direction is the preform material advancing into a loom of a preform forming machine, and wherein the second direction is the preform material retracting out of the loom of the preform forming machine.
